(19) United States
(12) Patent Application Publication
(10) Pub. No.: US 2010/0110276 A1
(43) Pub. Date: May 6, 2010

(54) Imaging apparatus

(75) Inventor: Yoko Fujimoto, Tokyo-to (JP)

Correspondence Address: THE NATH LAW GROUP, 112 South West Street, Alexandria, VA, 22314, US

(73) Assignee: VICTOR COMPANY OF JAPAN, LIMITED, Yokohama (JP)

(21) Appl. No.: 12/461,498

(22) Filed: Aug. 13, 2009

(30) Foreign Application Priority Data
Oct. 31, 2008 (JP) P2008-281035

(51) Int. Cl. H04N 5/225

(52) U.S. Cl. 348/360; 348/E05.022

(57) ABSTRACT

An imaging apparatus includes a main body, a handle, and a pad unit. The main body includes therein an imaging element which converts incident light coming through a lens into an electric signal. The handle is attached to a top face of the main body. The pad unit is attached to the handle and includes a case, a speaker incorporated in the case, a sound emitting part formed on the case to externally emit sound from the speaker, and an ear pad attached to the case. The pad unit is attached to the handle so as to turn around a rotation axis which is positioned not to pass the center of the sound emitting part. The sound emitting part is configured to move in the direction of an optical axis of the lens according to the turn of the pad unit.

### BACKGROUND OF THE INVENTION

1. Field of the Invention

The present invention relates to an imaging apparatus, and particularly, to an imaging apparatus provided with an ear pad having a speaker.

2. Description of the Related Art

The use of a camera-integrated image recording apparatus (hereinafter simply referred to as “imaging apparatus”) having a camera as an image input unit and an image recording unit for recording images taken with the camera is widespread.

The image recording unit records still images, movies, voices, and the like on a recording medium such as a tape, a hard disk, an optical disk, and a memory card. Generally, the image recording unit has a function of reproducing the recorded data from the recording medium.

Imaging apparatuses are largely classified into a shoulder type carried on a user's shoulder and a handheld type carried with a user's hand. Consumer imaging apparatuses are mainly of the handheld type because the handheld type is compact and light, and therefore, is easy to handle for everyone. On the other hand, the shoulder-type is advantageous in stably picking up images, and therefore, is especially used for broadcasting and business or by high amateurs. Some imaging apparatuses, in particular, those for business use, employ removable image recording units that are alternatively attached to a rear of an image input unit including an imaging element, to enable the recording and reproducing of image data with respect to various recording media.

When using an imaging apparatus, there is a need of simultaneously conducting photographing and voice monitoring. To meet the need, a shoulder-type imaging apparatus incorporating a speaker therein has been developed. Recent imaging apparatuses are compact and low-profile. When the shoulder-type imaging apparatus that is compact is shouldered, an ear of the user contacts a handle attached to the top of the imaging apparatus. To avoid this, the applicant of the present invention has proposed in Japanese Unexamined Patent Application Publication No. 2006-303571 (Patent Document 1) an imaging apparatus having a handle provided with a pad unit, the pad unit including a monitor speaker and a pad to be properly put to the ear of the user.

Generally, the shoulder-type imaging apparatus employs replaceable lenses to allow a variety of photographing modes. In this case, the gravitational center of the imaging apparatus in an optical axis direction varies depending on the lens attached to the apparatus, such as a short focus lens that is short in the optical axis direction and a long focus lens that is long in the optical axis direction.

If the imaging apparatus is capable of employing replaceable image recording units, the gravitational center of the apparatus also varies in the optical axis direction depending on the image recording unit attached to the apparatus. When carrying the imaging apparatus on a shoulder of the user, the user sets the gravitational center of the apparatus on the shoulder so that the user may take a stable photographing posture. Then, depending on the lens and image recording unit attached to the apparatus, the position of a handle of the imaging apparatus varies on the shoulder of the user in a front-rear direction. This results in shifting an ear position relative to the handle in the front-rear direction.

According to the imaging apparatus disclosed in Patent Document 1, the pad unit is fixed to a rear support of the handle, and therefore, is immovable in the front-rear direction. When the user shoulders this imaging apparatus with the gravitational center of the apparatus just on the shoulder of the user, the ear of the user may deviate from the pad unit in the front-rear direction depending on a lens or an image recording unit attached to the apparatus. This problem must be solved.

A compact imaging apparatus is usually short in a front-rear length (total length). When such a compact imaging apparatus is put on a shoulder of the user, an ear of the user may align with a handle of the apparatus, and therefore, in this case, a pad unit including an ear pad must be attached to the handle. The handle provided with the pad unit, however, is difficult to carry with a hand because the pad unit interferes with the hand.

### SUMMARY OF THE INVENTION

An object of the present invention is to provide an imaging apparatus that allows the user to carry the apparatus on a shoulder of the user in a stable posture, properly monitor voices without regard to a lens or an image recording unit attached to the apparatus, and surely carry a handle of the apparatus with a hand without the pad unit interfering with the hand.

In order to accomplish the object, a first aspect of the present invention provides an imaging apparatus including: a main body that includes therein an imaging element which converts incident light coming through a lens into an electric signal; a handle that is attached to a top face of the main body; and a pad unit that is attached to the handle and includes a case, a speaker incorporated in the case, a sound emitting part formed on the case to externally emit sound from the speaker, and an ear pad attached to the case, wherein the pad unit is attached to the handle so as to turn around a rotation axis which is positioned not to pass the center of the sound emitting part, and the sound emitting part is configured to move in the direction of an optical axis of the lens according to the turn of the pad unit.

According to a second aspect of the present invention, the imaging apparatus of the first aspect further includes a cord that has a first end connected to the speaker and a second end led into the handle, and a cord holder that holds the cord between the speaker and the handle.

According to a third aspect of the present invention, the imaging apparatus of the first aspect further includes a clicker that generates a click reaction when the pad unit is turned to a predetermined angular position.

The imaging apparatus according to these aspects of the present invention allows the user to shoulder the apparatus in a stable posture, properly monitor voices without regard to a shape of a lens or an image recording unit attached to the apparatus, and surely carry the apparatus by grasping the handle with a hand without the pad unit interfering with the hand.

### BRIEF DESCRIPTION OF THE DRAWINGS

FIG. 1 is a plan view (left side view) illustrating an imaging apparatus according to an exemplary embodiment of the present invention.

FIG. 2 is a perspective view illustrating the imaging apparatus according to the exemplary embodiment of the present invention.

FIG. 3 is a sectional view illustrating a pad unit of the imaging apparatus according to the exemplary embodiment of the present invention;

FIG. 4 is an exploded perspective view illustrating the pad unit and a pad attaching structure of the imaging apparatus according to the exemplary embodiment of the present invention.

FIGS. 5A to 5F illustrate a first part of the pad unit of the imaging apparatus according to the exemplary embodiment of the present invention.

FIGS. 6A to 6F illustrate a second part of the pad unit of the imaging apparatus according to the exemplary embodiment of the present invention.

FIGS. 7A to 7D illustrate the pad attaching structure of the imaging apparatus according to the exemplary embodiment of the present invention.

FIGS. 8A to 8F illustrate a third part of the pad unit of the imaging apparatus according to the exemplary embodiment of the present invention.

FIG. 9 illustrates an effect of the imaging apparatus according to the exemplary embodiment of the present invention.

FIG. 10 illustrates a turn of the pad unit of the imaging apparatus according to the exemplary embodiment of the present invention.

FIG. 11 is a partial perspective view illustrating an imaging apparatus according to a modification of the exemplary embodiment of the present invention.

### DESCRIPTION OF THE EMBODIMENTS

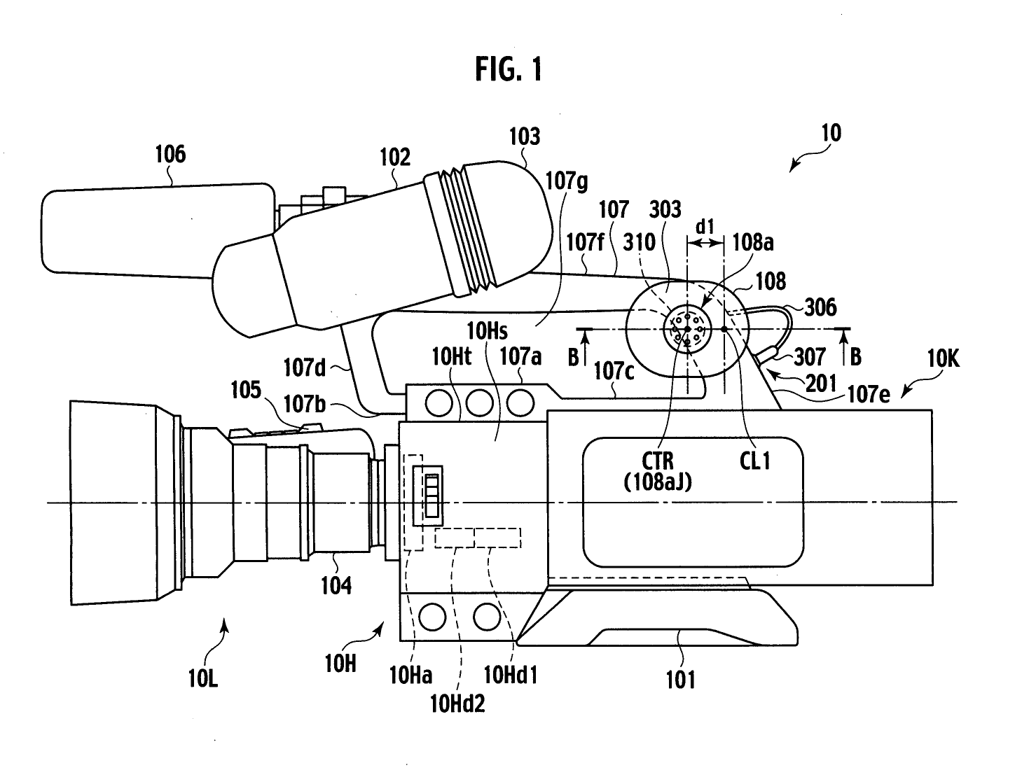

An imaging apparatus according to an exemplary embodiment of the present invention will be described with reference to FIGS. 1 to 11.

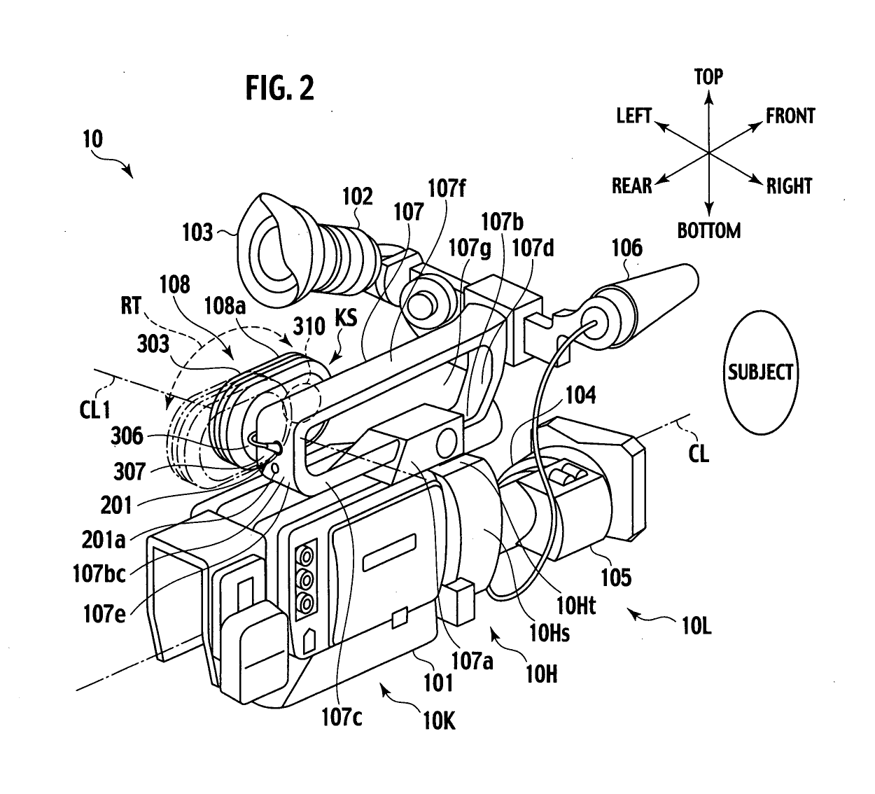

The imaging apparatus 10 according to the exemplary embodiment illustrated in FIGS. 1 and 2 is a camera-integrated imaging apparatus. The imaging apparatus 10 is of the shoulder type that is carried by the user on the user's shoulder when used for photographing. FIG. 1 is a side view illustrating the imaging apparatus 10 viewed from a left side point and FIG. 2 is a perspective view illustrating the imaging apparatus 10 viewed from a rear right upper point. Front, rear, left, right, top, and bottom sides of the imaging apparatus 10 are as illustrated in FIG. 2. The front side of the imaging apparatus 10 is a side where a subject to be photographed is present and a front-rear direction is a direction in which an optical axis CL of a lens unit 10L attached to the imaging apparatus 10 extends.

The imaging apparatus 10 has a main body 10H that incorporates an imaging element 10Ha, an image signal processor 10Hd1, and a voice signal processor 10Hd2 therein. The lens unit 10L on the front side and an image recording unit 10K on the rear side are removably attached to the main body 10H. The image recording unit 10K may have a reproducing function. The imaging element 10Ha converts image light made incident through the lens unit 10L into an electric signal and outputs the electric signal. The image signal processor 10Hd1 processes the electric signal from the imaging element 10Ha and outputs the processed electric signal as an image signal. According to the image signal, the image recording unit 10K records an image on a recording medium and an electronic view finder 102 displays the image thereon. The voice signal processor 10Hd2 processes a voice signal provided by a microphone 106 and sends the processed voice signal to a voice output terminal 201. The voice output terminal 201 is arranged at a back part of a handle 107. Voice signals outputted from the voice output terminal 201 include a voice signal from the microphone 106, a reproduced voice signal from the image recording unit 10K if the image recording unit 10K has a reproducing function, and a voice signal from an external microphone or player transferred through an external input terminal 201a (see FIG. 2). The voice signals outputted from the voice output terminal 201 are monitored through a reproducing device (such as an earphone or an external speaker) connected to the voice output terminal 201.

The lens unit 10L is selected from various lens units attachable to the main body 10H, such as a long focus lens, a short focus lens, and a zoom lens. The image recording unit 10K records images on a recording medium preset in the imaging apparatus 10 or a removable recording medium attached to the main body 10H. The recording medium may be a tape, a hard disk (HD), an optical disk, a memory card, or the like.

The main body 10H has a box-like casing 10Hs. The image recording unit 10K attached to the main body 10H has a bottom face to which a shoulder pad 101 is fitted. The shoulder pad 101 is connected to the casing 10Hs or the image recording unit 10K.

The casing 10Hs has a top face 10Ht to which the handle 107 is removably fixed with, for example, screws. A front part of the handle 107 is provided with the electronic view finder 102 having an eye cup 103 and the microphone 106. A rear left part of the handle 107 is provided with a pad unit 108. The details of the pad unit 108 will be described later. The lens unit 10L has a lens casing 104 that has a lens grip 105.

In FIG. 2, a rear face 107bc of the handle 107 has the voice output terminal 201 and external input terminal 201a. As described above, the voice output terminal 201 may be connected to an earphone or an external speaker to monitor voices.

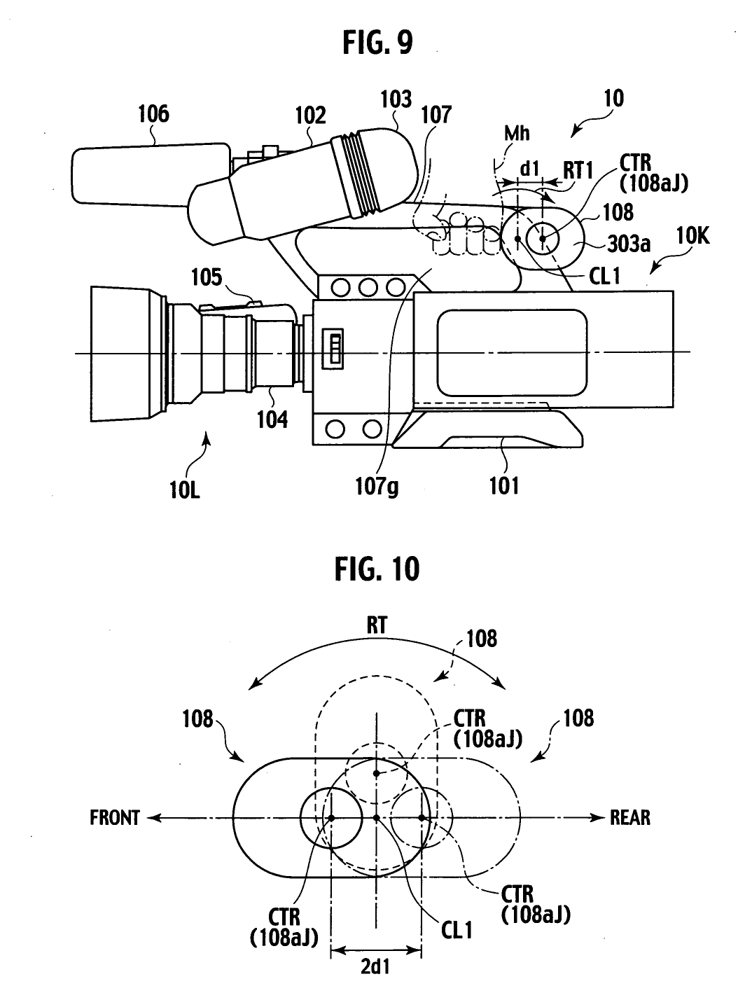

The handle 107 is made by die-casting metal such as magnesium into a frame structure or an arm structure. The handle 107 may be made by injection-molding resin. In FIG. 2, the handle 107 has a frame structure and consists of an attaching part 107a having an attachment to be fixed to the top face 10Ht of the casing 10Hs, front and rear bases 107b and 107c extending forward and rearward from the attaching part 107a, front and rear supports 107d and 107e upwardly extending from ends of the front and rear bases 107b and 107c, and a grip 107f connecting top ends of the front and rear supports 107d and 107e to each other. The attaching part 107a, front base 107b, front support 107d, grip 107f, rear support 107e, and rear base 107c surround an opening 107g into which fingers of the user are inserted (see FIG. 9) when the user holds the handle 107 with a hand.

The handle 107 is provided with the pad unit 108. The pad unit 108 is attached to the rear support 107e in the vicinity of the grip 107f or adjacent to a joint between the rear support 107e and the grip 107f.

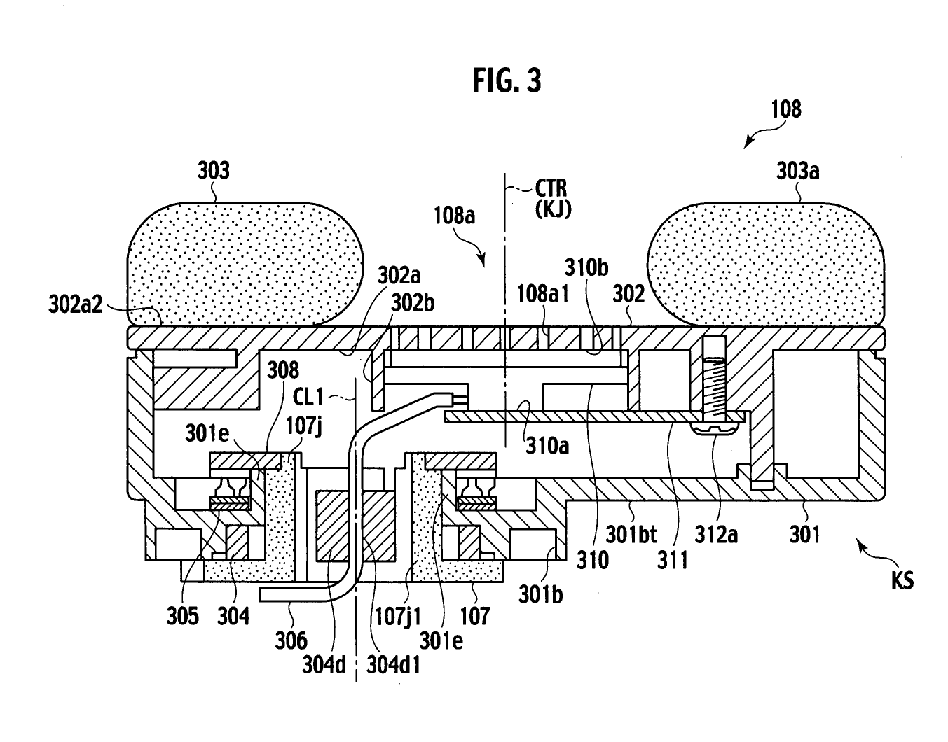

The pad unit 108 has a box-like case KS that is substantially closed and is a combination of a cheek base 301 and a pad holder 302 (see FIG. 3), a speaker 310 incorporated in the case KS, a cord 306 having a first end connected to the speaker 310 and a second end connected to a plug 307, an ear pad 303 attached to the case KS and having elasticity, and a sound emitting part 108a formed on the case KS as a hole for externally emitting voices from the speaker 310. The plug 307 connected to the second end of the cord 306 is connected to the voice output terminal 201, so that the user may monitor the voices through the pad unit 108.

The pad unit 108 is capable of turning around an axis CL1 that extends in a left-right direction of the imaging apparatus 10, so that the position of the pad unit 108 relative to the handle 107 is adjustable in the front-rear direction. This adjusting mechanism and the structure of the pad unit 108 will be described in detail.

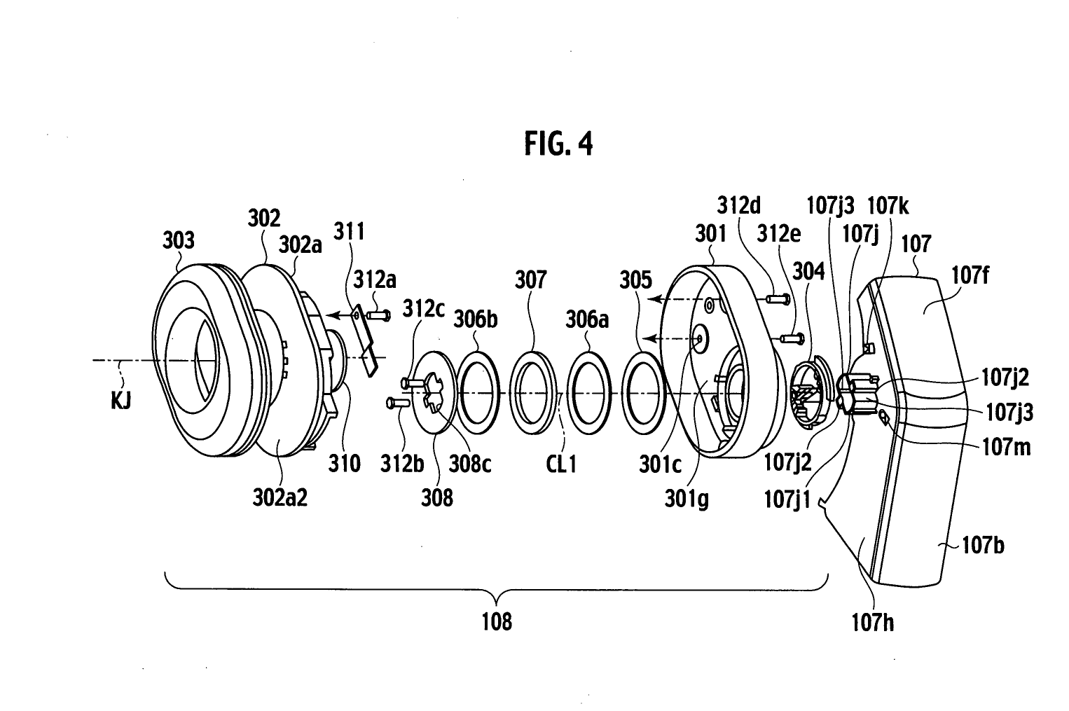

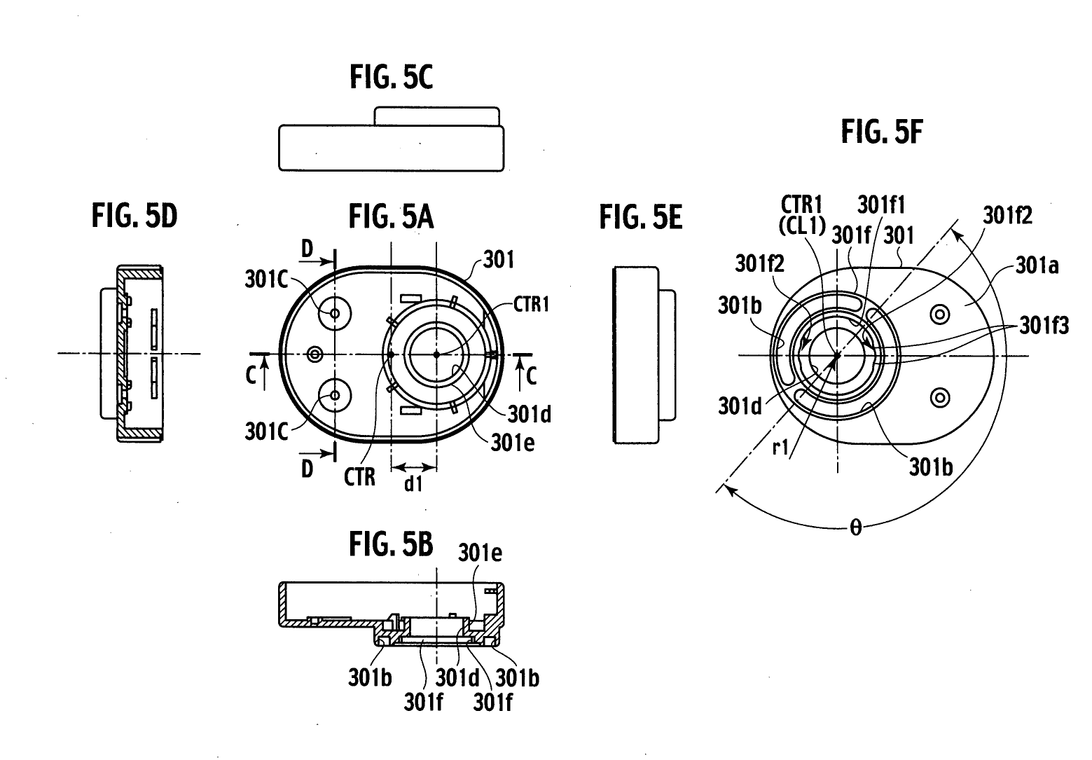

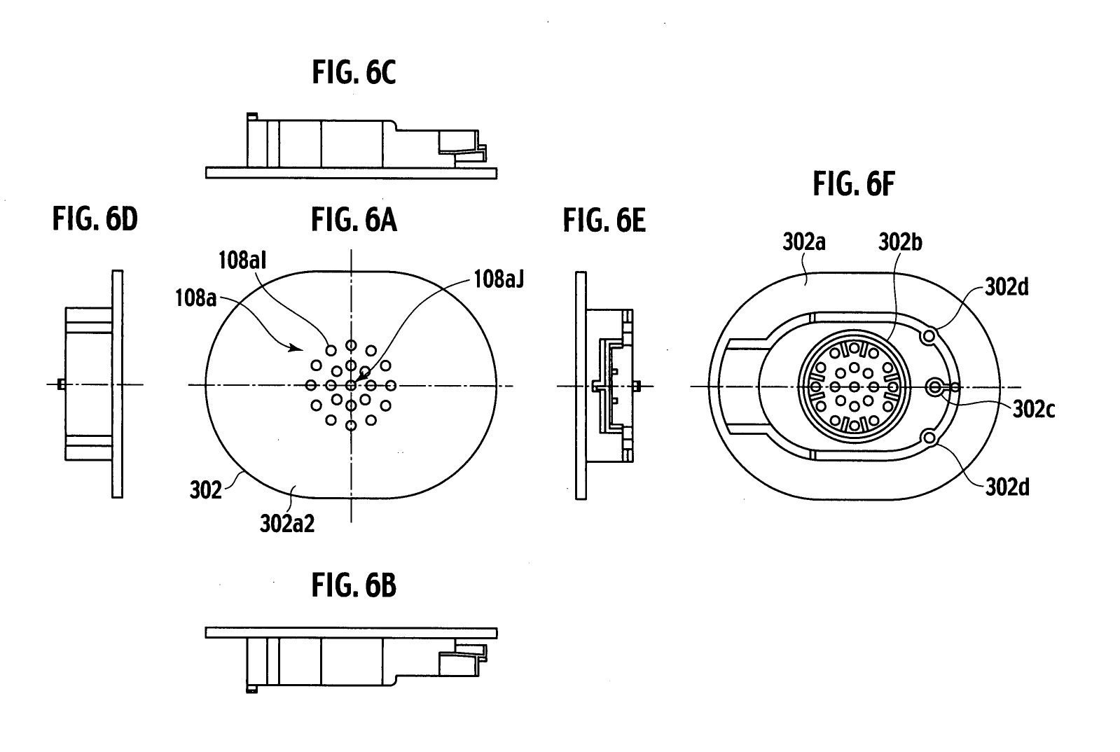

FIG. 3 is a sectional view taken along a line B-B of FIG. 1 and illustrating the pad unit 108 attached to the handle 107. FIG. 4 is an exploded perspective view illustrating the pad unit 108 and a part of the handle 107. FIGS. 5A to 5F illustrate the cheek base 301, in which FIG. 5A is a front view, FIG. 5B is a sectional view taken along a line C-C, FIG. 5C is a top view, FIG. 5D is a sectional view taken along a line D-D, FIG. 5E is a right side view, and FIG. 5F is a back view. FIGS. 6A to 6F illustrate the pad holder 302, in which FIG. 6A is a front view, FIG. 6B is a bottom view, FIG. 6C is a top view, FIG. 6D is a left side view, FIG. 6E is a right side view, and FIG. 6F is a back view.

The pad unit 108 has the box-like cheek base 301 that has an elliptic bottom 301bt and an opposite opening, the pad holder 302 that has an elliptic plate shape to cover the opening of the cheek base 301, the speaker 310 that is fitted to an inner face 302a of the pad holder 302, and the ear pad 303 that is attached to an outer face 302a 2 of the pad holder 302.

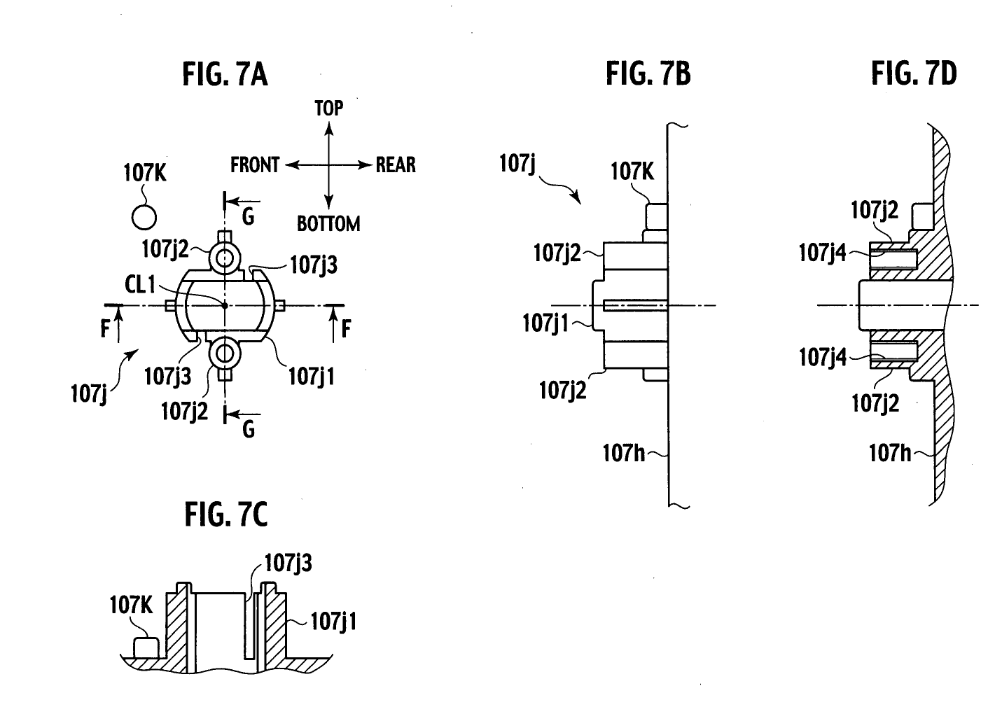

In FIG. 4, the handle 107 has a projection 107j that is formed on a left side face 107h of the rear support 107e adjacent to the grip 107f. FIGS. 7A to 7D illustrate the projection 107j, in which FIG. 7A is a front view (seen from the left side of the imaging apparatus 10), FIG. 7B is a right side view, FIG. 7C is a sectional view taken along a line F-F, and FIG. 7D is a sectional view taken along a line G-G.

In FIGS. 4 and 7A to 7D, the projection 107j includes a cylinder 107j1 cylindrically protruding and substantially having a double-D shape around the axis CL1 orthogonal to the left side face 107h and a pair of bosses 107j2. Each of the bosses 107j2 has a hole 107j4.

The cylinder 107j1 has a pair of slits 107j3 cut in the direction of the axis CL1 at opposite positions with respect to the axis CL1. On the left side face 107h of the handle 107, a pin 107k is formed above the projection 107j.

In FIGS. 4 and 6A to 6F, the pad holder 302 has an elliptic plate shape. The pad holder 302 may be made by injection-molding resin such as ABS (acrylonitrile butadiene styrene) resin.

The inner face 302a of the pad holder 302 has an annular wall 302b annularly protruding. The speaker 310 is fitted into the annular wall 302b. The inner face 302a also has a boss 302c having a hole into which a screw 312a is fastened to fix an end of a speaker bracket 311 that is a plate spring. A front end of the speaker bracket 311 resiliently pushes aback face 310a of the speaker 310, to thereby hold the speaker 310 in the pad holder 302.

An area of the pad holder 302 opposing a sound emitting face 310b of the speaker 310 defines the sound emitting part 108a to externally emit sound. The sound emitting part 108a is a substantially circular area containing a plurality of small sound emitting holes 108a1. According to the embodiment, a driving axis KJ of the speaker 310 agrees with a center axis 108aJ of the sound emitting part 108a. The axes KJ and 108aJ may deviate from each other. The speaker 310 is electrically connected to the cord 306 (illustrated in FIG. 3 and not illustrated in FIGS. 4 and 6A to 6F).

In FIGS. 4 and 5A to 5F, the cheek base 301 has an elliptic shape and a box-like structure with one open face. The cheek base 301 is formed by, for example, injection-molding resin such as ABS resin. The cheek base 301 has a circular opening 301d whose center CTR1 is deviated by a distance d1 from a center CTR of the cheek base 301 in the direction of a major axis of the elliptic cheek base 301, the center CTR being at the centers of the major and minor axes of the cheek base 301. An edge of the opening 301d forms an annular wall 301e that protrudes toward the open face of the cheek base 301. Opposite to the opening 301d in the major axis direction, there is a pair of through holes 301c. The cheek base 301 also has an annular wall 301f around the center CTR1. The annular wall 301f protrudes opposite to the open face of the cheek base 301 and has a flat end face that is provided with an arc groove 301b that concentrically extends around the center CTR1 within an angular range of θ. According to the embodiment, θ is approximately 180 degrees.

An inner face of the annular wall 301f defines a circumferential face 301f1 on which a pair of clickers 301f2 are formed opposite to each other with respect to the center CTR1. The clickers 301f2 each has a pair of projections 301f3 that protrude in a direction to reduce an inner radius r1 of the circumferential face 301f1.

In FIG. 4, the projection 107j of the handle 107 is received in a tension ring 304, the cheek base 301, a metal washer 305, a first slider ring 306a made of Polyslider (registered trade name), a wave washer 307, a second slider ring 306b, and a tension plate 308 in this sequence. With the wave washer 307 being properly crushed, screws 312b and 312c are screwed into the bosses 107j2, to thereby fix these parts to the handle 107.

As illustrated in FIG. 3 in detail, the metal washer 305, slider ring 306a, wave washer 307, and slider ring 306b are fitted to an outer circumferential face of the annular wall 301e of the cheek base 301. The tension ring 304 is positioned between the cheek base 301 and the handle 107 and is fitted to the projection 107j.

The wave washer 307 produces a preliminary pressure in the direction of the axis CL1 illustrated in FIG. 4. The tension plate 308 has a hole 308c at the center thereof, to pass the projection 107j of the handle 107, the shape of the hole 308c corresponding to the contour of the projection 107j. Accordingly, the tension plate 308 is restricted in turning around the axis CL1 relative to the handle 107. As a result, the cheek base 301 can turn around the axis CL1 relative to the tension plate 308 and handle 107 against static and dynamic (slide) frictional force produced by the resilient repulsive force of the wave washer 307.

The slider rings 306a and 306b that sandwich the wave washer 307 reduce friction when the cheek base 301 turns and allow the cheek base 301 to stably slide (turn). The metal washer 305 is in contact with the cheek base 301, to prevent the deformation of the cheek base 301 and secure the stable sliding motion of the cheek base 301.

The pin 107k of the handle 107 engages with the arc groove 301b formed on the back face 301a side of the cheek base 301. The arc groove 301b concentrically extends within the angular range of θ (see FIG. 5F) around the center CTR1 agreeing with the axis CL1. This enables the cheek base 301 to turn within the angular range of θ. According to the embodiment, θ is about 180 degrees.

The pad holder 302 incorporating the speaker 310 therein is fixed to the cheek base 301 with screws 312d and 312e that are passed through holes 301c of the cheek base 301 and are screwed into holes 302d (see FIG. 6F) of the pad holder 302. With this, the cheek base 301, pad holder 302, and speaker 310 turn together relative to the handle 107.

The cord 306 connected to the speaker 310 is passed through the inside of the projection 107j of the handle 107 as illustrated in FIG. 3 and is supported with the tension ring 304.

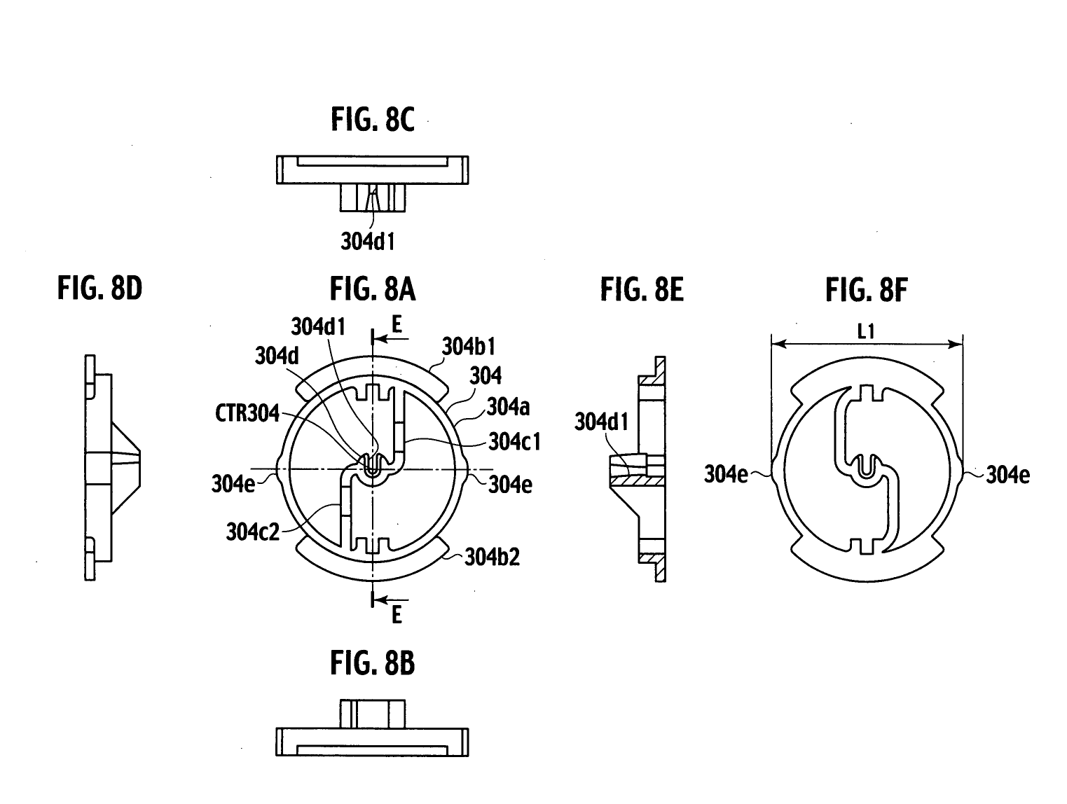

FIGS. 8A to 8F illustrate the tension ring 304, in which FIG. 8A is a front view (plan view) seen from the left side of FIG. 4, FIG. 8B is a lower side view, FIG. 8C is an upper side view, FIG. 8D is a left side view, FIG. 8E is a sectional view taken along a line E-E, and FIG. 8F is a back view.

The tension ring 304 includes an annular ring 304a, flanges 304b1 and 304b2 that oppose each other with respect to a center CTR304 and each extend outwardly from the annular ring 304a in a predetermined angular range, arms 304c1 and 304c2 that linearly inwardly extend from the annular ring 304a, and a cord holder 304d that is positioned at the center CTR304 and connects front ends of the arms 304c1 and 304c2 to each other.

The cord holder 304d has a slit 304d1 to hold the cord 306 extending from the speaker 310. The flanges 304b1 and 304b2 each is formed in the predetermined angular range, and sections of the annular ring 304a where no flange is formed are resiliently deformable in a radial direction. Outer circumferential faces of the flanges 304b1 and 304b2 are guided along the inner circumferential face of the annular wall 301f of the cheek base 301, and an axis passing through the center CTR304 of the tension ring 304 agrees with the center axis of the projection 107j, i.e., the rotation axis CL1 of the pad unit 108.

The tension ring 304 is formed by injection-molding resin such as POM (polyacetal) resin. The tension ring 304 is attached to the projection 107j of the handle 107 with the arms 304c1 and 304c2 being fitted to the slits 107j3 of the projection 107j.

As illustrated in FIG. 3, the cord 306 connected to the speaker 310 is fitted into the slit 304d1 of the cord holder 304d. The cord 306 is held by the cord holder 304d at the center of the projection 107j so that, when the pad unit 108 including the cheek base 301 and pad holder 302 turns around the axis CL1, the cord 306 never catches other parts or twists. Accordingly, the cord 306 is hardly disconnected due to a repetition of turns and secures high reliability for a long time. The annular ring 304a of the tension ring 304 has a pair of arc projections 304e that oppose each other with respect to the center CTR304 and outwardly protrude.

An end-to-end distance L1 (FIG. 8F) between the projections 304e is set to be larger than the diameter of the circumferential face 301f1 of the annular wall 301f of the cheek base 301. When the pad unit 108 is turned, the projections 304e of the tension ring 304 slide along the circumferential face 301f1 and the annular ring 304a inwardly deforms to produce resilient repulsive force that puts some load on the pad unit 108 that is turned.

The sizes of parts concerned are set so that the load on the pad unit 108 produced by the annular ring 304a makes the user who turns the pad unit 108 feel proper turning resistance. In addition, the user feels a click reaction when the user turns the pad unit 108 and when the projections 304e pass over the projections 301f3 of the clickers 301f2. At this time, the turning pad unit 108 is temporarily stopped by the clickers 301f2.

According to the embodiment, the two clickers 301f2 are opposed to each other at intervals of 180 degrees. This does not limit the present invention. The clickers 301f2 may be formed at optional angular positions to produce a click reaction at an optional position.

A route of laying the cord 306 electrically connected to the speaker 310 will be described.

The cord 306 is extended from the speaker 310, is held by the cord holder 304d of the tension ring 304, is led into the handle 107, is passed through a cord path 107m (see FIG. 4) that is formed at a base of the projection 107j of the handle 107 and communicates with the inside and outside of the handle 107 to each other, and is guided from the inside of the handle 107 to the outside thereof. The cord 306 may not be provided with the plug 307. In this case, the cord 306 is passed through the inside of the handle 107 and is directly connected to the voice signal processor 10Hd2.

The sound emitting part 108a of the pad holder 302 is provided with a nonwoven fabric (not illustrated) to prevent external foreign matter and dust from reaching the speaker 310. A face of the pad holder 302 opposite to the speaker 310 is provided with the annular ear pad 303. The ear pad 303 has a surface layer made of PU (polyurethane) leather and filled with urethane foam to provide elasticity.

As described above in detail, the imaging apparatus 10 according to the embodiment has the pad unit 108 that is attached to the handle 107 and is turnable around the axis CL1 (in the directions of arrows RT illustrated in FIG. 2) within a predetermined angular range. The user can turn the pad unit 108 while feeling proper turning resistance.

According to the embodiment, the predetermined angular range is about 180 degrees, and at least at each end of the angular range, the user can feel a click reaction. In the pad unit 108, the rotation axis CL1 is deviated by a predetermined distance d1 from the center CTR of the pad unit 108 or the center of the sound emitting part 108a that emits sound from the speaker 310. According to the embodiment, the center CTR of the pad unit 108 agrees with the driving axis KJ of the speaker 310. Also, the center CTR agrees with the center of the ear pad 303. According to the embodiment, the pad unit 108 is shaped so that the major axis direction of the pad unit 108 is in parallel with the optical axis CL of the imaging apparatus 10 at each end of the turning range of the pad unit 108. When the pad unit 108 is turned around the axis CL1, the center of the pad unit 108 moves in the direction of the optical axis CL. Since the turning range of the pad unit 108 is about 180 degrees according to the embodiment, the center of the pad unit 108 moves within a distance twice as large as the distance d1.

In FIG. 1, the pad unit 108 is at one end of the turning range, and in FIG. 9, the pad unit 108 is at the other end of the turning range. FIG. 10 roughly illustrates the attitudes of the pad unit 108 at three positions on a turning path of the pad unit 108. In FIG. 10, the pad unit 108 indicated with a continuous line is at the foremost position of FIG. 1, the pad unit 108 indicated with a dot-and-dash line is positioned at the rearmost position of FIG. 9, and the pad unit 108 indicated with a dotted line is at an intermediate position between them.

As is apparent in these drawings, the position of the driving axis KJ of the speaker 310 of the pad unit 108 is adjustable to the ear of the user by turning the pad unit 108 when the user shoulders the imaging apparatus 10 including the lens unit 10L and image recording unit 10K with the gravitational center of the imaging apparatus 10 including the units 10L and 10K being on the shoulder.

In FIG. 9, the pad unit 108 is retracted from the opening 107g of the handle 107. When the user carries the imaging apparatus 10 by grasping the handle 107 with the user's hand Mh, the user turns the pad unit 108 in the direction of the arrow RT1 (see FIG. 9) to retract the pad unit 108 to the position illustrated in FIG. 9. Then, the user can smoothly put the fingers into the opening 107g without bothered by the pad unit 108 and can surely grasp the handle 107 with the hand Mh.

It is preferable to set the sizes of parts of the imaging apparatus 10 so that the face 303a (see FIG. 3) of the ear pad 303 that comes in contact with the ear of the user is substantially on the same plane as the side face of the main body 10H.

The present invention is not limited to the above-described embodiment. Various modifications will be possible based on the embodiment without departing from the spirit of the present invention.

According to the embodiment, the driving axis KJ of the speaker 310 agrees with an axis passing through the center CTR of the cheek base 301. These axes may disagree with each other. If the driving axis KJ of the speaker 310 disagrees with the center axis 108aJ of the sound emitting part 108a that emits sound from the speaker 310, at least the center axis 108aJ of the sound emitting part 108a must be deviated from the rotation axis CL1.

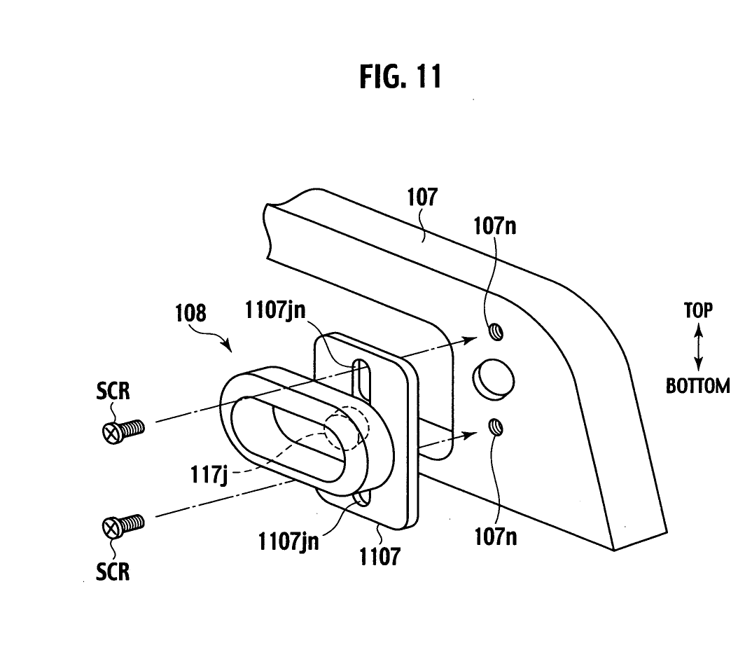

The projection 107j of the handle 107 may not be integral with the handle 107. As illustrated in FIG. 11, the projection 107j may be formed on a plate 1107 that is fixed to the handle 107 with screws that are fastened to long holes horizontally or vertically formed in the plate 1107.

FIG. 11 roughly illustrates the plate 1107 fitted to the handle 107. The handle 107 is provided with a pair of female threads 107n. The plate 1107 has a projection 1107j corresponding to the projection 107j and a pair of long holes 1107j n vertically formed. The pad unit 108 is attached to the plate 1107 in advance. Male screws SCR are passed through the long holes 1107jn and are screwed into the female threads 107n, to fix the plate 1107 having the pad unit 108 to the handle 107.

This configuration allows the fixing position of the plate 1107 on the handle 107 to be vertically moved, so that the position of the pad unit 108 relative to the ear of the user is precisely adjusted when the user puts the imaging apparatus 10 on the user's shoulder.

What is claimed is:

1. An imaging apparatus comprising:
a main body that includes therein an imaging element which converts incident light coming through a lens into an electric signal;
a handle that is attached to a top face of the main body; and
a pad unit that is attached to the handle and includes a case, a speaker incorporated in the case, a sound emitting part formed on the case to externally emit sound from the speaker, and an ear pad attached to the case,
wherein the pad unit is attached to the handle so as to turn around a rotation axis which is positioned not to pass the center of the sound emitting part, and
the sound emitting part is configured to move in the direction of an optical axis of the lens according to the turn of the pad unit.

2. The imaging apparatus according to claim 1, further comprising:
a cord that has a first end connected to the speaker and a second end led into the handle; and
a cord holder that holds the cord between the speaker and the handle.

3. The imaging apparatus according to claim 1, further comprising:
a clicker that generates a click reaction when the pad unit is turned to a predetermined angular position.
